(19) United States
(12) Patent Application Publication
(10) Pub. No.: US 2002/0082179 A1
(43) Pub. Date: Jun. 27, 2002

(54) Cleaning method, apparatus therefor, cleaning object cleaned thereby, and hopper

(76) Inventors: Masaki Okazawa, Kanagawa (JP); Hideo Iwama, Kanagawa (JP); Bunryo Sato, Tokyo (JP); Hiroshi Kowase, Saitama (JP); Nobuo Hirasawa, Tokyo (JP)

Correspondence Address: FITZPATRICK CELLA HARPER & SCINTO, 30 ROCKEFELLER PLAZA, NEW YORK, NY, 10112, US

(21) Appl. No.: 10/005,409

(22) Filed: Dec. 10, 2001

(30) Foreign Application Priority Data
Dec. 12, 2000 (JP) 378012/2000

(51) Int. Cl. C11D 1/00

(52) U.S. Cl. 510/276

(57) ABSTRACT

In cleaning operation using dry ice pellets, a bridging phenomenon of the dry ice pellets occurs. Also, static electricity is generated, so a good cleaning effect cannot be obtained. This invention is directed to solve these problems. In order to solve these problems, a cleaning apparatus has a blast nozzle, a device for pneumatically feeding a carrier gas to the blast nozzle, and a device for supplying dry ice pellets to the blast nozzle, and blasts a cleaning object (W) with the dry ice pellets, together with the carrier gas, from the blast nozzle, thereby cleaning a surface of the cleaning object (W). This cleaning apparatus includes an air supplying device for supplying destaticizing air to a cleaning portion of the cleaning object (W) to be cleaned by the blast nozzle, and a charging device for charging the destaticizing air with a polarity opposite to the polarity of the charged dry ice pellets.

### FIELD OF THE INVENTION

The present invention relates to a cleaning method of cleaning a surface of a cleaning object by blasting the cleaning object with dry ice pellets from a blast nozzle together with a carrier gas, and an apparatus for the same.

The present also relates to a cleaning object cleaned by the cleaning method and apparatus, and a hopper for reserving the dry ice pellets.

### BACKGROUND OF THE INVENTION

A need for reusing or so-called recycling the constituent components and units of business and electric devices has become strong in terms of effective utilization of resources, countermeasure for environmental pollution, and the like.

To recycle the constituent components and units of various types of devices, they must be removed from the devices, and whether they function correctly must be checked. Also, these components and units must be maintained in or restored to an almost brand-new state.

In practice, as these devices are used, they are soiled or contaminated in the atmosphere where they have been used, and cleaning operation is needed to remove their soil and contamination. For example, regarding a copying machine or printer as an example of a business device, as it uses toner as the image forming material, soil or contamination due to toner dust attaches to, e.g., the fixing unit and components around it. In these devices, a printed wiring board having a built-in electrical circuit for electricity control is mounted. Such printed wiring board is contaminated by dust accumulated by static electricity.

Regarding electric home appliances including an air conditioner such as a cooler, a television, and a refrigerator, regulations for recycling electric home appliances have been put into operation. A recycling system is also needed for other home electrical appliances including information devices such as a personal computer, business devices such as a printer, or other industrial devices in terms of the environmental and resources problems.

To cope with this demand of recycling the electric appliances, a technique for causing granular dry ice, i.e., dry ice pellets, as a cleaning agent to impinge on a surface to be cleaned, thereby removing a substance attaching to the surface to be cleaned is disclosed in, e.g., Japanese Patent Laid-Open No. 61-15749. Japanese Patent Laid-Open No. 10-202210 discloses a cleaning system for automatically carrying out the cleaning operation of a recycling component while preventing it from being damaged.

The techniques disclosed in the above references disclose a system for removing soil of a recycling component of an OA (Office Automation) device by blasting it with dry ice pellets. Cleaning operation is performed by moving a blast nozzle, which blasts the dry ice pellets together with pressurized air as a carrier gas, along the surface of the recycling component as a cleaning object.

Japanese Patent Laid-Open No. 10-202208 discloses a technique for performing cleaning operation by using solid pellets such as dry ice pellets as a cleaning agent. Also, Japanese Patent Laid-Open No. 51-60095 is known as a cleaning technique with a sand blast method using a sublimation material.

The various types of electrical products described above have a built-in printed wiring board mounted with electronic components. To meet the demand for recycling by disassembling and cleaning these products, a countermeasure against static electricity must be taken for these electronic components.

When cleaning the surface of a cleaning object by blasting it with dry ice pellets, the dry ice pellets are blasted, together with a carrier gas, from a hopper for reserving the dry ice pellets toward the cleaning surface of the cleaning object by a blast nozzle. When the dry ice pellets are conveyed in a supply pipe path at a high speed from the hopper to the blast nozzle, they may be electrostatically charged by mutual friction during conveyance and friction with the inner wall of a flexible pipe that forms the supply pipe path. Since the cleaning object is blasted with charged dry ice, the cleaning object itself is electrostatically charged. Accordingly, dust attaches again to the cleaning object after cleaning, and sometimes a good cleaning effect cannot be obtained. Also, a person in charge of cleaning operation himself may be electrified by static electricity.

Furthermore, when the cleaning object has a built-in printed wiring board mounted with electronic components and the like, the electronic components and the like are damaged by static electricity described above. Then, the cleaning object cannot be reused.

### SUMMARY OF THE INVENTION

It is an object of the present invention to provide a cleaning method which is not adversely affected by static electricity generated by cleaning operation, an apparatus for the same, and a cleaning object cleaned by them.

It is another object of the present invention to provide a hopper for reserving dry ice pellets which are blasted, together with a carrier gas, from a blast nozzle toward the cleaning object in order to clean the surface of the cleaning object, without causing a bridging phenomenon.

According to the first aspect of the present invention, there is provided a cleaning method characterized by comprising the steps of pneumatically feeding a carrier gas to a blast nozzle for cleaning a cleaning object, supplying dry ice pellets to the blast nozzle, blasting the cleaning object with the dry ice pellets, together with the carrier gas, from the blast nozzle, thus cleaning a surface of the cleaning object, and supplying air, charged with a polarity opposite to a polarity of the charged dry ice pellets, to a cleaning portion of a target to be blasted by the blast nozzle.

According to the present invention, when the dry ice pellets are blasted, together with the carrier gas, from the blast nozzle to the cleaning object, soil attaching to the surface of the cleaning object is blown off by the collision force generated by blasting operation and the pressure of expansion accompanying sublimation of the dry ice pellets. In this case, when supplying the dry ice pellets to the blast nozzle, static triboelectricity is generated. When air charged with a polarity opposite to the polarity of the static triboelectricity of the charged dry ice pellets is supplied to the cleaning portion of the cleaning object, the charged state of the dry ice pellets is electrically neutralized. As a result, an inconvenience that soil blown off from the surface of the cleaning object reattaches to the surface of the cleaning object due to the static electricity of the dry ice pellets can be prevented.

According to the second aspect of the present invention, there is provided a cleaning apparatus which has a blast nozzle, means for pneumatically feeding a carrier gas to the blast nozzle, and means for supplying dry ice pellets to the blast nozzle, and blasts a cleaning object with the dry ice pellets, together with the carrier gas, from the blast nozzle, thereby cleaning a surface of the cleaning object, characterized by comprising air supplying means for supplying air to a cleaning portion of a target to be blasted by the blast nozzle, and charging means for charging air with a polarity opposite to a polarity of the charged dry ice pellets.

According to the present invention, when the carrier gas is pneumatically fed to the blast nozzle and the dry ice pellets are supplied to the blast nozzle, the dry ice pellets are blasted, together with the carrier gas, from the blast nozzle to the cleaning object. Soil attaching to the surface of the cleaning object is blown off by the collision force generated by blasting operation and the pressure of expansion accompanying sublimation of the dry ice pellets. In this case, when supplying the dry ice pellets to the blast nozzle, static triboelectricity is generated. When air is charged with a polarity opposite to the polarity of the static triboelectricity of the charged dry ice pellets and is supplied to the cleaning portion of the cleaning object, the charged state of the dry ice pellets is electrically neutralized. As a result, an inconvenience that soil-blown off from the surface of the cleaning object reattaches to the surface of the cleaning object due to the static electricity of the dry ice pellets can be prevented.

According to the third aspect of the present invention, there is provided a cleaning object cleaned by the cleaning method according to the first aspect of the present invention, or cleaned by using the cleaning apparatus according to the second aspect of the present invention. Such cleaning object is also incorporated in the scope of the present invention.

According to the fourth aspect of the present invention, there is provided a hopper for reserving dry ice pellets which are blasted, together with a carrier gas, from a blast nozzle to a cleaning object, so as to clean a surface of the cleaning object, characterized by comprising agitating means for agitating the dry ice pellets, thereby preventing bridging of the dry ice pellets.

According to the present invention, the dry ice pellets reserved in the hopper are agitated by the agitating means. Thus, the bridging phenomenon that the dry ice pellets fuse with each other by sublimation of part of the dry ice pellets is prevented.

Other objects and advantages besides those discussed above shall be apparent to those skilled in the art from the description of a preferred embodiment of the invention which follows. In the description, reference is made to accompanying drawings, which form a part hereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a perspective view showing the outer appearance of a fixing unit in a copying machine as an example of a cleaning object as the target of the present invention;

FIG. 2 is a mechanical illustration showing the schematic structure of a cleaning apparatus according to an embodiment of the present invention that can realize a cleaning method according to the present invention;

FIG. 3 is an extracted enlarged view showing the outer appearance of a cleaning gun portion having a built-in blast nozzle in the embodiment shown in FIG. 2;

FIG. 4 is a sectional view showing the schematic structure of a hopper portion in the embodiment shown in FIG. 2;

FIG. 5 is a sectional view taken along the line V-V of FIG. 4 in a state from which an agitating means is omitted;

FIG. 6 is an illustration of a hopper according to another embodiment of the present invention;

FIG. 7 is an illustration of a hopper according to still another embodiment of the present invention;

FIG. 8 is an illustration of a hopper according to a different embodiment of the present invention;

FIG. 9 is an illustration of a hopper according to still another embodiment of the present invention;

FIG. 10 is an illustration of a hopper according to still another embodiment of the present invention; and

FIG. 11 is an illustration of a hopper according to still another embodiment of the present invention.

### DETAILED DESCRIPTION OF THE PREFERRED EMBODIMENTS

A cleaning method according to the first embodiment of the present invention can also comprise the step of charging a cleaning operation atmosphere with charges that cancel charges generated in the cleaning object after collision with the dry ice pellets.

Air can have charges that cancel charges generated in the cleaning object after collision with the dry ice pellets. This air can be directly supplied to the cleaning portion of the cleaning object from a second blast nozzle separately from the carrier gas blast nozzle.

Alternatively, air may at least have charges that cancel charges of the dry ice pellets before collision against the cleaning object. In this case, air can be mixed in the carrier gas immediately before being blasted from the blast nozzle.

The carrier gas can be air.

In a cleaning apparatus according to the second embodiment of the present invention, an air supply means may have a second blast nozzle for directly supplying air to the cleaning portion of the cleaning object separately of a carrier gas.

A charging means can have a means capable of controlling charges.

The apparatus can also have a second charging means for charging a cleaning operation atmosphere with charges that cancel charges generated in the cleaning object after collision with the dry ice pellets. In this case, the second charging means can have a means capable of controlling charges.

In a hopper according to the fourth embodiment of the present invention, an agitating means can have an agitation rotating shaft with a distal end projecting into the hopper, an agitation blade attached to the distal end of the agitation rotating shaft, and a driving source connected to the proximal end of the agitation rotating shaft to rotatably drive the agitation rotating shaft. In this case, a plurality of agitation rotating shafts may be arranged with directions different from each other. One agitation blade is preferably arranged at the lower end of the hopper. Alternatively, the agitating means may also have a means capable of controlling the rotational speed of the agitation rotating shaft.

The agitating means can have at least one agitation rod with a distal end projecting into the hopper, an agitation arm attached to the distal end of the agitation rod, and a driving source connected to the proximal end of the agitation rod to reciprocally move the agitation rod in its longitudinal direction. In this case, the agitating means can further have a means capable of controlling the moving speed of the agitation rod.

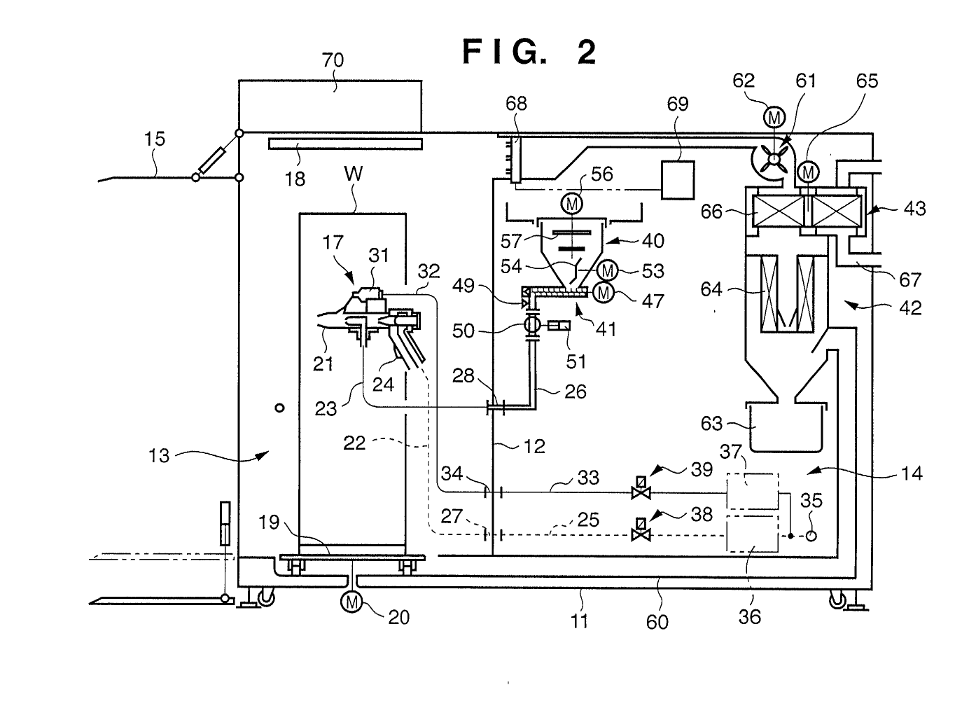

Embodiments in which the present invention is applied to a fixing unit in a copying machine will be described in detail with reference to FIGS. 2 to 11. The present invention is not limited to these embodiments. These embodiments may be combined, and the present invention can be applied to other techniques to be incorporated in the scope of the present invention described in the appended claims of this specification.

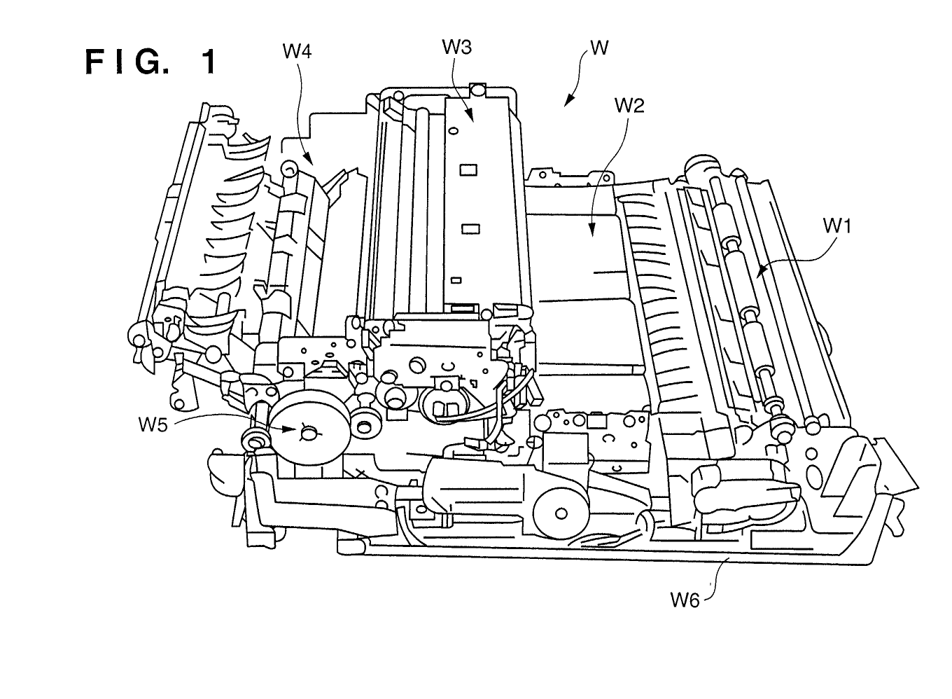

The cleaning object in this embodiment is a fixing unit W in a copying machine as shown in FIG. 1. The fixing unit W has a feed section W1 to which a toner-developed copy sheet is transferred from a developing unit (not shown), a fixing section W3 for fixing the toner image of the copy sheet fed from the feed section W1 through a convey section W2, a delivery section W4 for delivering the copy sheet with the fixed toner image from the convey section W2 to the outside of the fixing unit W, a driving system W5 for driving the feed section W1, convey section W2, fixing section W3, and delivery section W4, a controller (not shown) for controlling the operation of the driving system W5, and a frame W6 to which the feed section W1, convey section W2, fixing section W3, delivery section W4, driving system W5, and controller are attached. In the copying machine, various types of units in the copying machine are soiled or contaminated in accordance with the frequency they are used and the atmosphere where they are used. The soil or contamination is caused by various factors, e.g., soil caused by scattering of the toner accommodated in the copying machine, soil accompanying scattering of the toner, which occurs while the units are being repaired or maintained, or dust attracted and attached by the static electricity generated in the electrical circuits formed in the respective units.

FIG. 2 shows the schematic structure of a cleaning apparatus according to this embodiment. The interior of a housing 11 is-partitioned by a partition 12 into a cleaning booth 13 and supply/recovery booth 14. The housing 11 has an opening/closing door 15 openable to load or unload the fixing unit W in or from the cleaning booth 13, and a supply/delivery table 16 which, when loading/unloading the fixing unit W, can move upward from the state indicated by a solid line in FIG. 2 to the same height as that of the floor surface of the cleaning booth 13, to improve the operability of the loading/unloading operation. Also, a transparent window (not shown) through which the operator observes the interior of the cleaning booth 13, and a glove box (not shown) for allowing the operator to operate a cleaning gun 17 in the cleaning booth 13 from the outside of the cleaning booth 13 are formed on that side wall portion of the housing 11 which forms the cleaning booth 13.

A illumination device 18 which allows observing operation state from the outside through the window described above is provided to the cleaning booth 13. A rotary table 19, to which the fixing unit W is removably fixed with a predetermined posture, is provided to the cleaning booth 13 to be rotatable about a vertical axis. The rotary table 19 is rotatably driven by a table driving motor 20. The cleaning gun 17 with a blast nozzle 21 for blasting, together with a carrier gas, dry ice pellets for cleaning the fixing unit W is suspended in the cleaning booth 13 by using a hoist (not shown) or the like. The operator can manually operate the position and posture of the cleaning gun 17 from the outside of the cleaning booth 13 through the glove box.

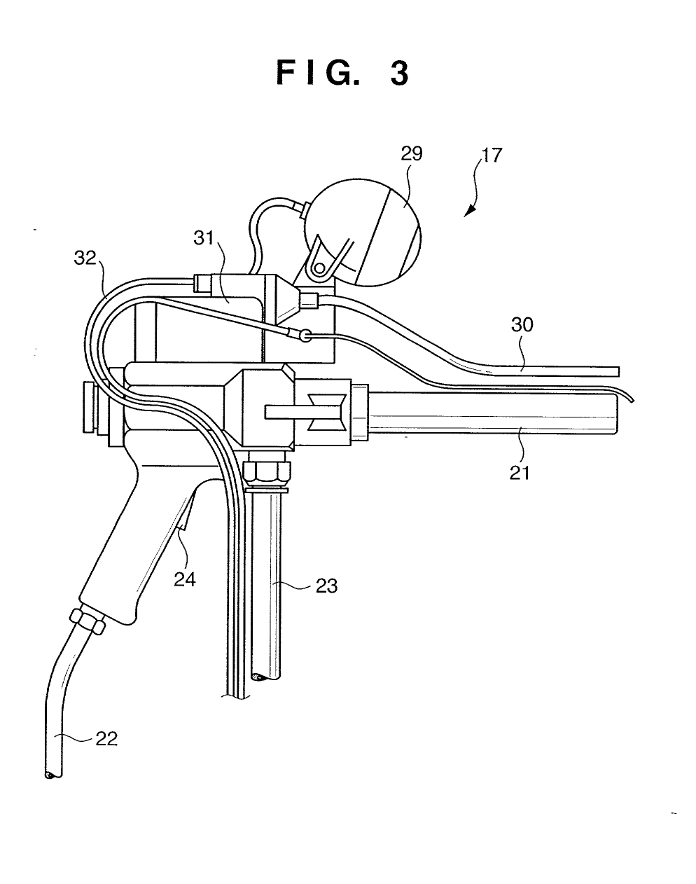

FIG. 3 shows the outer appearance of the cleaning gun 17 portion of this embodiment. A flexible carrier gas supply pipe 22 and pellet supply pipe 23 are connected to the cleaning gun 17. The cleaning gun 17 has the blast nozzle 21 for blasting the dry ice pellets together with the carrier gas toward the fixing unit W, and a trigger 24 to be operated by the operator for adjusting the blast state of the carrier gas from the blast nozzle 21. The dry ice pellets supplied to the cleaning gun 17 are drawn out from the pellet supply pipe 23 by a negative pressure generated by the carrier gas flowing in the cleaning gun 17. The dry ice pellets, together with the carrier gas, are blown off from the blast nozzle 21 to the fixing unit W at a high speed.

The flexible carrier gas supply pipe 22 and pellet supply pipe 23 are connected to a stationary carrier gas supply pipe 25 and stationary pellet supply pipe 26, which are fixed to the supply/recovery booth 14, through joints 27 and 28 formed on the partition 12, so they are suspended, together with the cleaning gun 17, from the housing 11 in the cleaning booth 13. To form the pellet supply pipe 23 in the cleaning booth 13, a flexible piping material with excellent corrosion resistance and low-temperature brittleness, e.g., a Teflon (polytetrafluoroethylene) tube with an inner diameter of 13 mm and an outer diameter of 16 mm and available from Du Pont, must be used, and a metal pipe such as one used to form the stationary pellet supply pipe 26 cannot be used. Therefore, due to the friction of the dry ice pellets moving in the pellet supply pipe 23 at a speed of, e.g., 100 m to 180 m (preferably 150 m) per second and friction between the dry ice pellets and the inner wall of the pellet supply pipe 23, the dry ice pellets are sometimes undesirably electrostatically charged with negative (or positive) electricity. The present invention solves this inconvenience.

A lamp 29, provided in addition to the illumination device 18 fixed in the cleaning booth 13, for illuminating the working portion, an air blow-off nozzle 30 for blowing off destaticizing air to that portion of the fixing unit W which is to be blasted by the blast nozzle 21, and a charger 31 for charging destaticizing air blown off from the air blow-off nozzle 30 with the opposite polarity (positive in this embodiment) to the polarity of the charged dry ice pellets are mounted in the cleaning gun 17. A flexible destaticizing air supply pipe 32 is connected to the air blow-off nozzle 30 and suspended, together with the carrier gas supply pipe 22 and the like, from the housing 11 in the cleaning booth 13, and is connected to a stationary destaticizing air supply pipe 33, fixed to the supply/recovery booth 14, through a joint 34 formed on the partition 12.

In this embodiment, the air blow-off nozzle 30 is arranged in parallel with the blast nozzle 21. Alternatively, destaticizing air may be supplied into the blast nozzle 21. It is also effective to blow off a detergent, together with the carrier gas, dry ice pellets, and destaticizing air, from the cleaning gun 17 to the cleaning portion of the fixing unit so that the cleaning effect for the fixing unit W is improved.

In this embodiment, as the carrier gas, air from an air compressor (not shown) serving as the same air supply source as for destaticizing air is used. Pressurized air is supplied from the air compressor arranged outside the housing 11 to the stationary carrier gas supply pipe 25 and stationary destaticizing air supply pipe 33 through a joint 35 formed on the housing 11. Pressure adjustment devices 36 and 37 for reducing the pressures of the carrier gas and destaticizing air to predetermined pressures, and opening/closing solenoid valves 38 and 39 for performing switching operation between supply and discharge of the carrier gas and destaticizing air, are formed midway along the stationary carrier gas supply pipe 25 and stationary destaticizing air supply pipe 33.

A hopper 40 for reserving about 30 liters of dry ice pellets each forming a round rod with, e.g., a diameter of 3 mm and a length of about 3 mm to 10 mm, a feeder 41 arranged immediately under the hopper 40 to feed out the dry ice pellets in the hopper 40 to the stationary pellet supply pipe 26, a dust removing device 42 for removing toner particles and dust blown away from the fixing unit W by the cleaning gun 17, and a recovery device 43 for recovering carbon dioxide are formed in the supply/recovery booth 14.

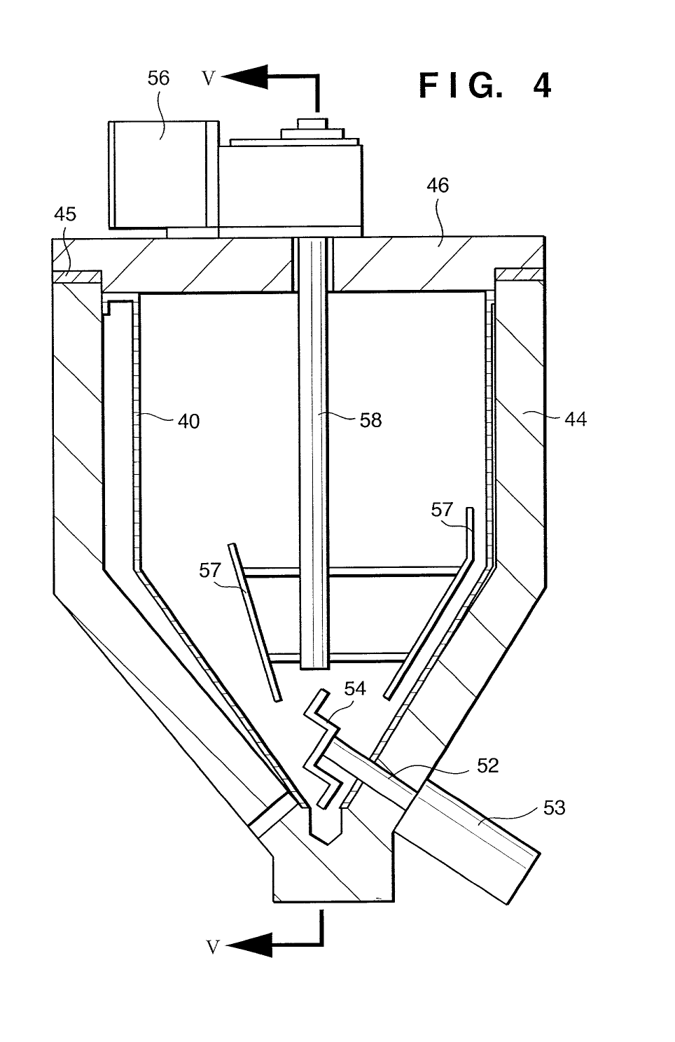

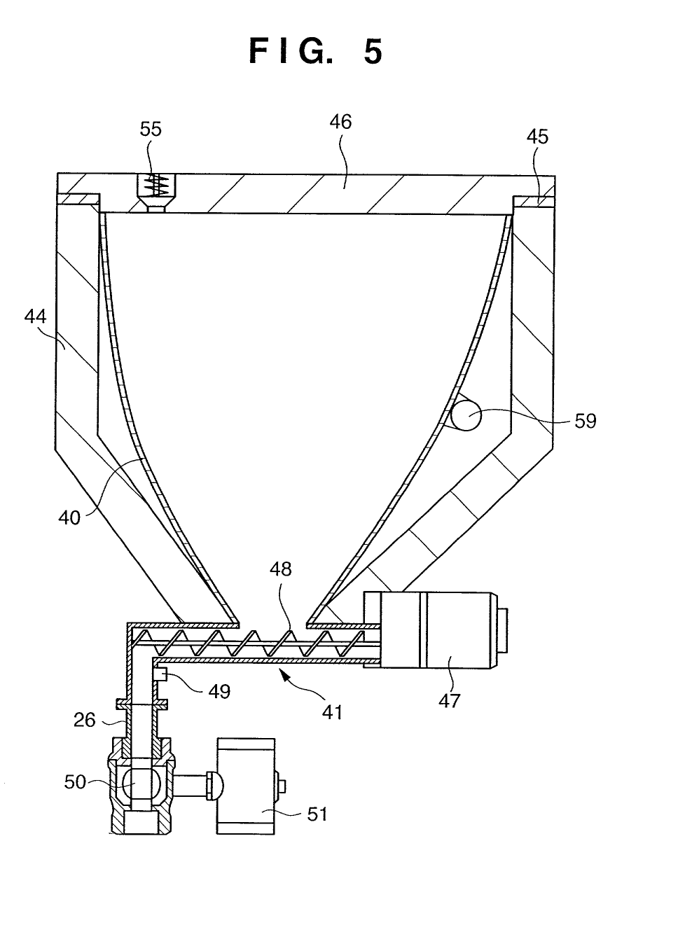

FIG. 4 shows the enlarged sectional structure of the hopper 40 of this embodiment, and FIG. 5 shows its sectional structure taken along the line V-V. More specifically, the feeder 41 with a screw 48 rotated by a feed driving motor 47 is arranged at the lower end of the hopper 40 covered by a heat insulation wall 44 and an openable heat insulation lid 46 through a seal member 45. The feeder 41 conveys the dry ice pellets from the lower end of the hopper 40 to the stationary pellet supply pipe 26. A sensor 49 for detecting the presence/absence of the dry ice pellets moving in the stationary pellet supply pipe 26, an opening/closing valve 50 for performing switching operation between supply and discharge of the dry ice pellets, a crusher (not shown) for crushing the dry ice pellets further finely to, e.g., a diameter of 0.5 mm or less and a length of 2 mm or less, and the like are interposed midway along the stationary pellet supply pipe 26. When the opening/closing valve 50 operated by an actuator 51 opens/closes the path of the stationary pellet supply pipe 26, supply and discharge of the dry ice pellets to and from the cleaning gun 17 are controlled.

An upwardly tilted first agitation rotating shaft 52 is rotatably attached to the lower end of the hopper 40. A first blade driving motor 53 is connected to the proximal end of the first agitation rotating shaft 52 and rotatably drives it at a low speed of, e.g., about 5 rpm. A first agitation blade 54 is integrally fixed to the distal end of the first agitation rotating shaft 52 located in the hopper 40, to agitate the dry ice pellets located at the lower end of the hopper 40, thereby preventing bridging of the dry ice pellets. The first agitation blade 54 has such a blade shape that it can agitate the dry ice pellets in the entire lower end of the hopper 40 as much as possible. A second blade driving motor 56 is mounted on the heat insulation lid 46 having a built-in relief valve 55. The second blade driving motor 56 is connected to the upper end of a vertical second agitation rotating shaft 58. Second agitation blades 57 formed of a wire project radially from the second agitation rotating shaft 58 at an angular distance of 180°. When the second blade driving motor 56 is actuated and the second agitation rotating shaft 58 is rotated at a low speed of, e.g., about 9 rpm, the dry ice pellets located at the center of the hopper 40 are agitated, so they are prevented from causing bridging. Therefore, in this embodiment, the agitation rotating shafts 52 and 58, agitation blades 54 and 57, driving motors 53 and 56, and the like apparently make up the agitating means of the present invention.

If the urging force of the agitation blades 54 and 57 against the dry ice pellets increases, sublimation of the dry ice pellets progresses, and bridging undesirably tends to occur easily. Hence, the first and second agitation rotating shafts 52 and 58 need not be rotated at high speeds. Also, consideration must be made so the rotational resistances of the agitation blades 54 and 57 against the dry ice pellets do not become excessively large.

In this embodiment, a vibrator 59 for vibrating the hopper 40 at a low frequency is mounted on the outer wall of the hopper 40 in order that the inner wall of the hopper 40 and the dry ice pellets are prevented from being fixed to each other.

The lower end of the cleaning booth 13 and the dust removing device 42 communicate with each other through a suction pipe 60. The dust removing device 42 in this embodiment has an exhaust blower 61 for drawing by suction a gas and the like in the cleaning booth 13 through the suction pipe 60, a blower driving motor 62 for rotatably driving the exhaust blower 61, a dust tank 63 for reserving comparatively heavy toner particles and dust by utilizing gravity, and a filter 64 for catching fine particles that did not fall into the recovery pipe 63. The filter 64 and dust tank 63 can be exchanged when necessary. A recovery device 43 for recovering carbon dioxide passing through the filter 64 is incorporated between the filter 64 and exhaust blower 61.

The recovery device 43 of this embodiment has a membrane 66 which is rotated by a membrane driving motor 65 at a predetermined speed, and a recovery pipe 67 for recovering carbon dioxide caught by the membrane 66. The recovery pipe 67 is extended outside the housing 11 and is guided to a dry ice manufacturing device (not shown).

Air which has passed through the exhaust blower 61 and from which carbon dioxide is recovered is mostly exhausted outside the housing 11, and is then partly returned to the cleaning booth 13 through an ionizer 68. The ionizer 68 electrostatically charges air passing through it by an RF power supply 69. In this embodiment, the atmosphere of the cleaning booth 13 is electrostatically charged to be slightly positive (or negative), so charges formed by negative (or positive) static electricity generated in the fixing unit W after collision with the dry ice pellets are canceled.

Therefore, charges formed by the charger 31 suffice as far as they cancel the charges of the dry ice pellets before colliding against the cleaning portion of the fixing unit W.

It is confirmed by the experiment performed by the present inventors that, if the charged state of the dry ice pellets cannot be correctly grasped, electrostatic charging of the fixing unit W can be neutralized to a certain degree by performing control operation of switching the polarity of charged air blown off from the air blow-off nozzle 30 and ionizer 68 at every predetermined period of time. A method of alternately blowing off positive charged air and negative charged air in a switching manner to the cleaning surface of the cleaning object is also incorporated in the present invention. This method is effective probably because excessive charged particles are continuously discharged, together with air and carbon dioxide, from the suction pipe 60 to the outside of the cleaning booth 13.

The driving motors 20, 47, 53, 56, 62, and 65, opening/closing solenoid valves 38 and 39, actuator 51, vibrator 59, and the like are driven in an interlocked manner, when necessary, by a control device 70 with an operating portion (not shown) formed at the upper end of the housing 11 and operable by the operator.

Since the controller of the fixing unit W has a built-in printed wiring board with electronic components (not shown) and the like mounted thereon, it must be prevented from being damaged by static electricity during cleaning operation. According to the present invention, the dry ice pellets blasted in the charged state from the cleaning gun 17 are electrically neutralized by charged air with the opposite polarity, and electrostatic charging accompanying collision of the dry ice pellets against the fixing unit is also neutralized simultaneously. Therefore, damages caused by static electricity to the printed wiring board and the like of the controller can be prevented reliably.

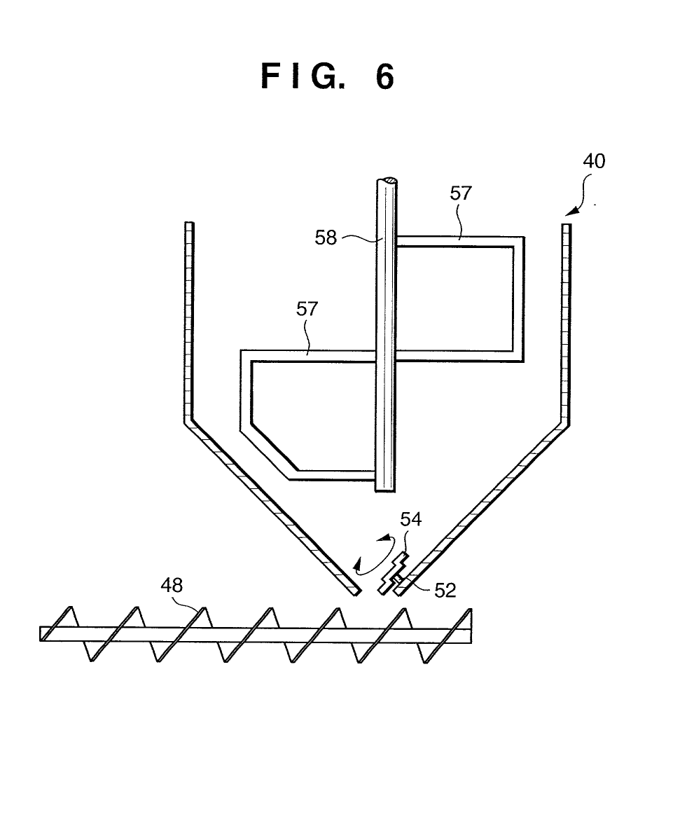

The above embodiment describes the agitating means in which the two second agitation blades 57 with different lengths in the radial direction project from the second agitation rotating shaft 58. Any agitating means other than that of this embodiment, e.g., one with one of the arrangements shown in FIGS. 6 to 11 schematically showing other embodiments of the agitating means, can naturally be employed as far as it can prevent bridging of the dry ice pellets in the hopper 40.

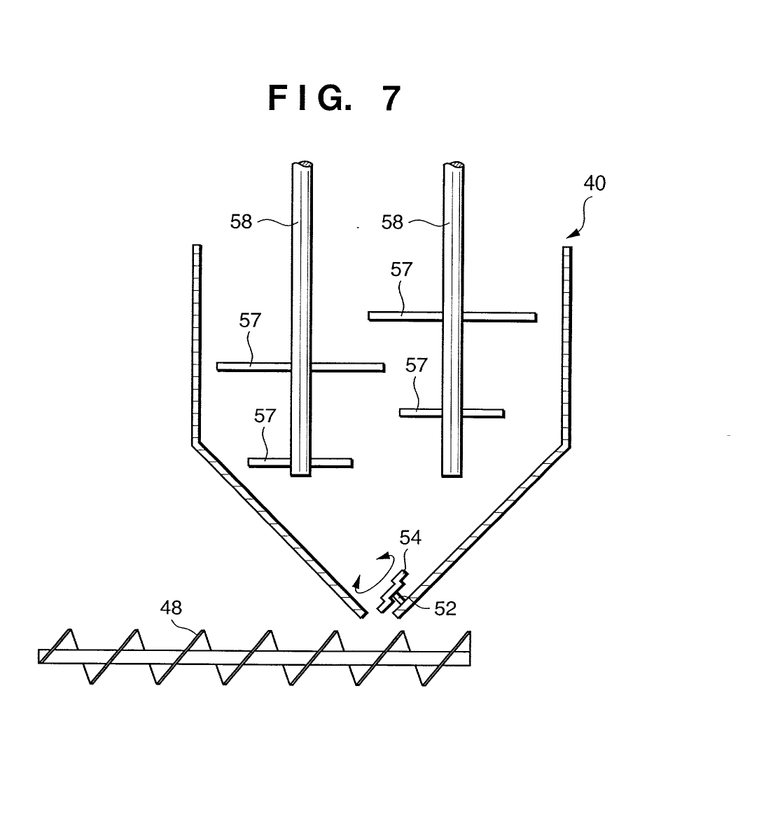

In these embodiments, the elements with the same functions as those of the above embodiment are denoted by the same reference numerals, and a repetitive description thereof will be omitted. More specifically, in the agitating means shown in FIG. 6, a pair of frame-like second agitation blades 57 are attached to a second agitation rotating shaft 58 to be vertically spaced apart from each other with an angular interval of 180°. This can reliably prevent bridging of the dry ice pellets throughout the entire vertical range of a hopper 40. In an agitating means of the embodiment shown in FIG. 7, a plurality of (two in the embodiment shown in FIG. 7) second agitation rotating shafts 58 are vertically arranged. In this embodiment, second agitation blades 57 of one second agitation rotating shaft 58 are shifted from second agitation blades 57 of the other second agitation rotating shaft 58 in the vertical direction. Thus, the two second agitation rotating shafts 58 can be arranged close to each other.

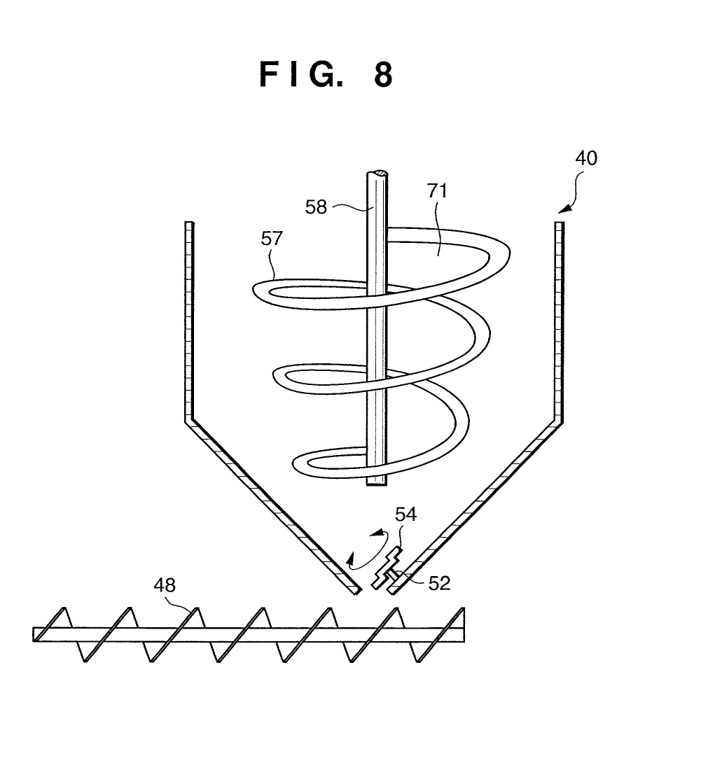

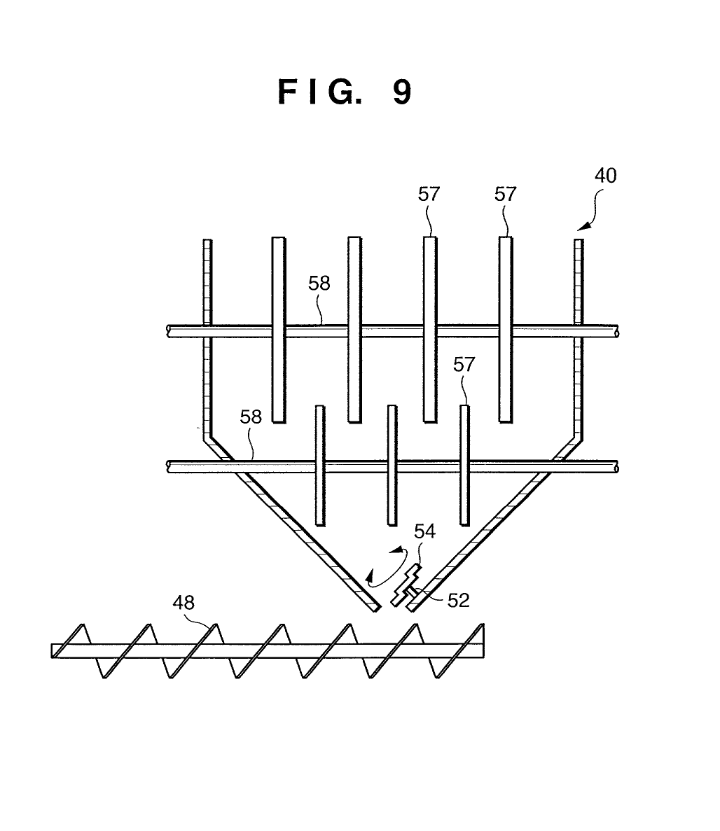

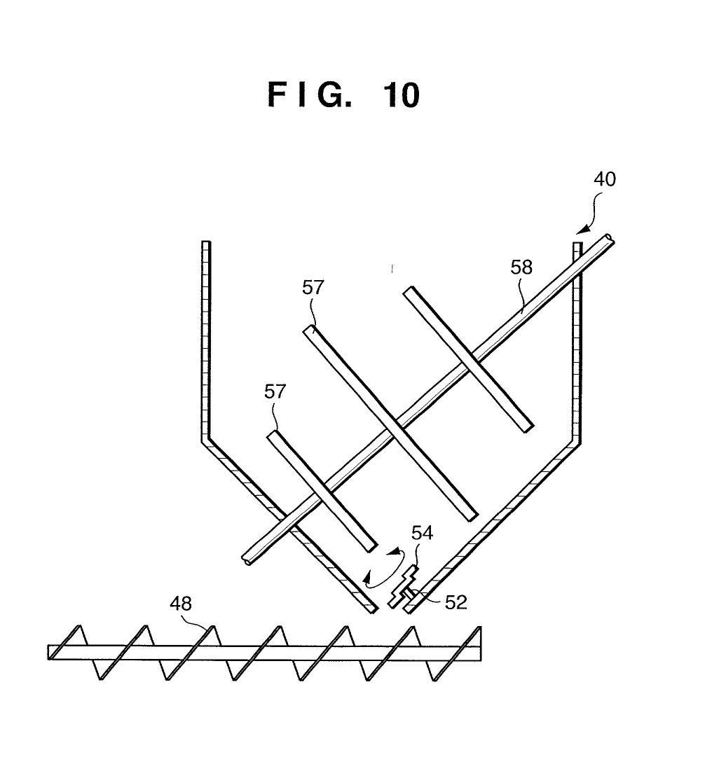

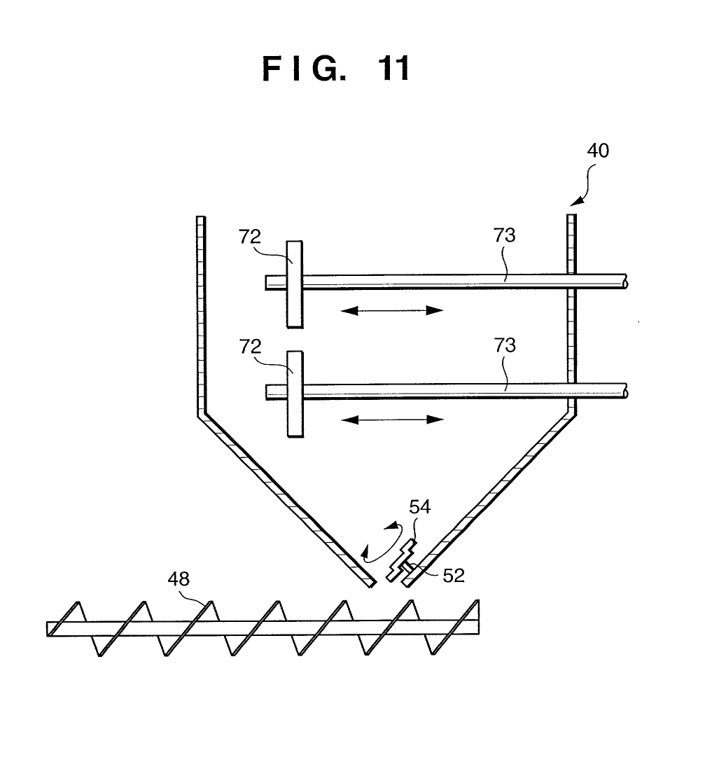

In the embodiment shown in FIG. 8, a second agitation blade 57 of a second agitation rotating shaft 58 is spirally formed. The second agitation rotating shaft 58 can be rotated in the forward and reverse directions regardless of the spiral direction of the second agitation blade 57. In this case, a gap 71 is formed between the circumferential surface of the second agitation rotating shaft 58 and the inner side of the second agitation blade 57 so an excessively large contact pressure is not generated between the second agitation blade 57 and dry ice pellets. The second agitation blade 57 floats above the second agitation rotating shaft 58, while its upper and lower ends are fixed to the second agitation rotating shaft 58. In the embodiment shown in FIG. 9, at least one (two in the embodiment shown in FIG. 9) second agitation rotating shaft 58 is rotatably attached to a hopper 40 such that its axis becomes horizontal. In the embodiment shown in FIG. 9, second agitation blades 57 of a lower second agitation rotating shaft 58 are located between second agitation blades 57 of an upper second agitation rotating shaft 58. Thus, the two second agitation rotating shafts 58 can be arranged close to each other. In the agitating means shown in FIG. 10, a second agitation rotating shaft 58 is rotatably attached to a hopper 40 to be inclined with respect to the hopper 40, so that its axis is perpendicular to the axis of a first agitation rotating shaft 52. In the agitating means shown in FIG. 11, at least one (two in the embodiment shown in FIG. 11) agitation rod 73 extends in the horizontal direction. The proximal end of the agitation rod 73 is connected to an actuator (not shown), e.g., a hydraulic cylinder or an electrical motor through a crank mechanism or rack-and-pinion mechanism, and an agitation arm 72 radially projects from that distal end of the agitation rod 73 which is located in a hopper 40. The agitation rod 73 is reciprocally moved in the horizontal direction, thereby agitating dry ice pellets in the hopper 40. The direction of the agitation rod 73 is not limited to the horizontal direction, but can be vertical or be inclined as shown in FIG. 10.

The cleaning method of the embodiments described above has the step of supplying air, charged with the opposite polarity to the charged polarity of the dry ice pellets, to the cleaning portion of the blast target which is to be blasted with the blast nozzle. Therefore, static electricity generated in the dry ice pellets can be destaticized reliably. Thus, static electricity is prevented from being generated in the cleaning object by static electricity of the dry ice pellets, and a good cleaning effect can be obtained.

If the cleaning method further has the step of charging the cleaning operation atmosphere with charges that cancel charges generated in the cleaning object after collision with the dry ice pellets, static electricity generated when the dry ice pellets collide against the cleaning object can also be reliably neutralized. Thus, an inconvenience that dust reattaches to the cleaning object after cleaning can be prevented.

If air has charges that cancel charges generated in the cleaning object after collision with the dry ice pellets, static electricity generated when the dry ice pellets collides against the cleaning object can also be neutralized reliably. Thus, an inconvenience that that reattaches to the cleaning object after cleaning can be prevented.

If air has at least charges that cancel the charges of the dry ice pellets before collision against the cleaning object, static electricity generated in the dry ice pellets can be destaticized reliably. Thus, static electricity is prevented from being generated in the cleaning object by static electricity of the dry ice pellets.

When air is mixed in the carrier gas immediately before being blasted from the blast nozzle, contact of the dry ice pellets in the charged state and air charged with the opposite charged state to that of the dry ice pellets is promoted, so the dry ice pellets can be destaticized more reliably.

When air is directly supplied to the cleaning portion of the cleaning object from the second blast nozzle separately from the carrier gas blast nozzle, destaticizing air can be reliably blown off only to a portion where static electricity is generated when being collided with the dry ice pellets, and only the charged portion can be destaticized reliably.

When the carrier gas is air, any special carrier gas need not be used, and the running cost can be reduced.

The cleaning apparatus according to the present invention has an air supplying means for supplying air to a cleaning portion of a target to be blasted by the blast nozzle, and a charging means for charging air with a polarity opposite to a polarity of the charged dry ice pellets. Static electricity generated in the dry ice pellets can be destaticized reliably, and static electricity is prevented from being generated in the cleaning object by static electricity of the dry ice pellets. Thus, a good cleaning object can be obtained.

If the air supply means has a second blast nozzle for directly supplying air to the cleaning portion of the cleaning object separately from the carrier gas blast nozzle, destaticizing air can be reliably blown off only to a portion where static electricity is generated upon collision with the dry ice pellets. Thus, only the charged portion can be reliably destaticized.

When the charging means has a means capable of controlling charges, it can impart air with optimal charges in accordance with the charges of the dry ice pellets or the like. Thus, generated static electricity can be destaticized reliably.

When a second charging means is further provided which charges a cleaning operation atmosphere with charges that cancel charges generated in the cleaning object after collision with the dry ice pellets, it can also reliably neutralize static electricity generated when the dry ice pellets collide against the cleaning object. Thus, an inconvenience that dust reattaches to the cleaning object after cleaning can be prevented.

When the second charging means has a means capable of controlling charges, charges of the cleaning operation atmosphere can be controlled in the optimal manner in units of individual cleaning objects. Thus, static electricity generated in each cleaning object can be destaticized reliably.

According to the cleaning object of the above embodiment, since static electricity generated during cleaning operation is removed, reattaching of dust due to static electricity after cleaning operation can be prevented.

The hopper according to the above embodiment has an agitating means for agitating the dry ice pellets, thereby preventing bridging of the dry ice pellets. Thus, a bridging phenomenon of the dry ice pellets in the hopper can be prevented, and the dry ice pellets reserved in the hopper can be smoothly fed out toward the blast nozzle.

When a plurality of agitation rotating shafts are arranged with directions different from each other, the agitating effect of the dry ice pellets in the hopper can be improved, so the bridging phenomenon of the dry ice pellets can be prevented more reliably.

When one agitation blade is arranged at a lower end of the hopper, the bridging phenomenon of the dry ice pellets located at the lower end of the hopper can be prevented reliably. Thus, the dry ice pellets can be smoothly fed out from the lower end of the hopper to the blast nozzle.

When the agitating means further has a means capable of controlling the rotational speed of the agitation rotating shaft, the interior of the hopper can be agitated with an optimal rotational speed in accordance with the state of the dry ice pellets and the like. Thus, the bridging phenomenon of the dry ice pellets can be prevented more reliably.

When the agitating means further has a means capable of controlling the moving speed of the agitation rod, the interior of the hopper can be agitated with an optimal moving speed in accordance with the state of the dry ice pellets and the like. Thus, the bridging phenomenon of the dry ice pellets can be prevented more reliably.

The present invention is not limited to the above embodiments and various changes and modifications can be made within the spirit and scope of the present invention. Therefore, to apprise the public of the scope of the present invention the following claims are made.

What is claimed is:

1. A cleaning method characterized by comprising the steps of:
pneumatically feeding a carrier gas to a blast nozzle for cleaning a cleaning object;
supplying dry ice pellets to the blast nozzle;
blasting the cleaning object with the dry ice pellets, together with the carrier gas, from the blast nozzle, thus cleaning a surface of the cleaning object; and
supplying air, charged with a polarity opposite to a polarity of the charged dry ice pellets, to a cleaning portion of a target to be blasted by the blast nozzle.

2. The method according to claim 1, characterized by further comprising the step of charging a cleaning operation atmosphere with charges that cancel charges generated in the cleaning object after collision with the dry ice pellets.

3. The method according to claim 1, characterized in that air has charges that cancel charges generated in the cleaning object after collision with the dry ice pellets.

4. The method according to claim 1, characterized in that air has at least charges that cancel charges of the dry ice pellets before collision against the cleaning object.

5. The method according to claim 4, characterized in that air is mixed in the carrier gas immediately before being blasted from the blast nozzle.

6. The method according to claim 3, characterized in that air is directly supplied to the cleaning portion of the cleaning object from a second blast nozzle separately from the carrier gas blast nozzle.

7. The method according to claim 1, characterized in that the carrier gas is air.

8. A cleaning apparatus which has a blast nozzle, means for pneumatically sending a carrier gas to said blast nozzle, and means for supplying dry ice pellets to said blast nozzle, and,blasts a cleaning object with the dry ice pellets, together with the carrier gas, from said blast nozzle, thereby cleaning a surface of the cleaning object, characterized by comprising:
air supplying means for supplying air to a cleaning portion of a target to be blasted by said blast nozzle; and
charging means for charging air with a polarity opposite to a polarity of the charged dry ice pellets.

9. The apparatus according to claim 8, characterized in that said air supply means has a second blast nozzle for directly supplying air to the cleaning portion of the cleaning object separately from the carrier gas blast nozzle.

10. The apparatus according to claim 8, characterized in that said charging means has means capable of controlling charges.

11. The apparatus according to claim 8, characterized by further comprising second charging means for charging a cleaning operation atmosphere with charges that cancel charges generated in the cleaning object after collision with the dry ice pellets.

12. The apparatus according to claim 11, characterized in that said second charging means has means capable of controlling charges.

13. A cleaning object cleaned by the cleaning method according to claim 1.

14. A cleaning object cleaned by the cleaning apparatus according to claim 9.

15. A hopper for reserving dry ice pellets which are blasted, together with a carrier gas, from a blast nozzle to a cleaning object, so as to clean a surface of the cleaning object, characterized by comprising
agitating means for agitating the dry ice pellets, thereby preventing bridging of the dry ice pellets.

16. The hopper according to claim 15, characterized in that said agitating means has an agitation rotating shaft with a distal end projecting into the hopper, an agitation blade attached to the distal end of the agitation rotating shaft, and a driving source connected to a proximal end of the agitation rotating shaft to rotatably drive the agitation rotating shaft.

17. The hopper according to claim 16, characterized in that the agitation rotating shaft includes a plurality of agitation rotating shafts arranged with directions different from each other.

18. The hopper according to claim 16, characterized in that one agitation blade is arranged at a lower end of the hopper.

19. The hopper according to claim 16, characterized in that said agitating means further has means capable of controlling a rotational speed of the agitation rotating shaft.

20. The hopper according to claim 15, characterized in that said agitating means has at least one agitation rod with a distal end projecting into the hopper, an agitation arm attached to the distal end of the agitation rod, and a driving source connected to a proximal end of the agitation rod to reciprocally move the agitation rod in a longitudinal direction thereof.

21. The hopper according to claim 20, characterized in that said agitating means further has means capable of controlling a moving speed of the agitation rod.
